(19) United States
(12) Patent Application Publication
(10) Pub. No.: US 2006/0007826 A1
(43) Pub. Date: Jan. 12, 2006

(54) Recording/reproducing apparatus, recording/reproducing method and information storage medium using the same

(75) Inventors: Sung-hee Hwang, Seoul (KR); Jung-wan Ko, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/159,346

(22) Filed: Jun. 23, 2005

(30) Foreign Application Priority Data
Jul. 12, 2004 (KR) 2004-54096

(51) Int. Cl. G11B 5/09

(52) U.S. Cl. 369/53.2; 369/47.1

(57) ABSTRACT

An apparatus and method to record data on an optical recording information storage medium, an apparatus and method to reproduce data on an optical recording information storage medium, and an optical recording information storage medium using the same. The apparatus to record data on an optical recording information storage medium includes: a write unit which writes data on the medium; and a controller which compresses temporary disk management information (TDMI), which is information for managing the medium, and controls the write unit to write the compressed TDMI in a disk management area. Accordingly, since exhaustion of a temporary disk management area (TDMA) is delayed, the disk lifetime may be extended.

### CROSS-REFERENCE TO RELATED APPLICATIONS

This application claims the benefit of Korean Application No. 2004-54096, filed Jul. 12, 2004, in the Korean Intellectual Property Office, the disclosure of which is incorporated herein by reference.

### BACKGROUND OF THE INVENTION

1. Field of the Invention

An aspect of the present invention relates to a disk, and, more particularly, to an apparatus and method of recording data on an optical recording information storage medium, an apparatus and method of reproducing data from an optical recording information storage medium, and an optical recording information storage medium using the same.

2. Description of the Related Art

A characteristic of write-once information storage media is that overwriting recorded data is impossible. Accordingly, only some recording methods may be used, such as disc at once recording or sequential recording in track units.

FIG. 1 illustrates a file system recording method in a write-once information storage medium 100 according to the prior art.

For example, in the conventional write-once information storage medium 100, data may be written as shown in FIG. 1. That is, a file system 110 is written on a first location of the write-once information storage medium 100, and if first data 120 is written on the next location after the file system 110, a modified file system 130 which reflects the new recording situation is written on the next location after the first data 120. Likewise, if second data 140 is written on the next location after the file system 130, a modified file system 150 which reflects the new recording situation is written on the next location after the second data 140. In the conventional write-once information storage medium 100, information of the file system is dispersed to a plurality of locations, which slows reproduction.

In general, two types of command are used to write data on an information storage medium. One is a simple data write command, and the other is a verify-after-write command, which asks for verification after the writing, to ensure a reliability of data. The latter is performed for data such as file system data, for which data reliability is essential since the entire medium cannot be reproduced if the file system data is corrupted. General data, on the other hand, is only damaged in file units if a defect is generated. Therefore, the verify-after-write command substantially guarantees the reliability of data by a use of a defect management method when the reliability of data is degraded through the verification process after the writing.

However, when a host tries to update data of an area already written on a write-once information storage medium, achieving this aim with only the two commands is difficult. Therefore, a method is required in which a data updating operation in a write-once information storage medium may be performed as would be performed for a rewritable information storage medium.

Such a method is a logical overwrite method. In the logical overwrite method, data recorded in the write-once information storage medium is updated using a defect management scheme.

The logical overwrite method reduces the disk lifetime, due to fast exhaustion of an information area for managing the logical overwrite method.

### SUMMARY OF THE INVENTION

An aspect of the present invention provides a recording apparatus and method to extend a lifetime of a disk, a reproducing apparatus and method to extend a lifetime of a disk, and an optical write information storage medium using the same.

According to an aspect of the present invention, there is provided a recording apparatus to write data on an information storage medium, the apparatus comprising: a write unit which writes data on the medium; and a controller which controls the write unit to compress temporary disk management information (TDMI), which manages the medium, and writes the compressed TDMI in a disk management area.

The compressed TDMI may exclude a temporary disk definition structure (TDDS).

The controller may separately compress each item of information included in the TDMI.

The controller may exclude header information when the TDMI is compressed.

According to another aspect of the present invention, there is provided a reproducing apparatus to reproduce data from an information storage medium, the apparatus comprising: a read unit which reads data from the medium; and a controller which decompresses temporary disk management information (TDMI) written on the medium when the data written on the medium is reproduced, and uses the decompressed TDMI for the data reproduction.

According to another aspect of the present invention, there is provided an information storage medium in which temporary disk management information (TDMI) is compressed and written in a disk management area.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a file system recording method in a write-once information storage medium according to the prior art;

FIG. 2 is a schematic block diagram of a recording/reproducing apparatus according to an embodiment of the present invention;

FIG. 3A is a detailed block diagram of the recording/reproducing apparatus shown in FIG. 2;

FIG. 3B is a detailed block diagram of a DSP shown in FIG. 3A;

FIG. 4 shows the structure of a disk to which an embodiment of the present invention is applied;

FIGS. 5A through 5D illustrate disk areas related to a recording operation using a logical overwrite according to an embodiment of the present invention;

FIGS. 6A and 6B illustrate a defect list according to an embodiment of the present invention;

FIG. 7 shows the detailed structure of a TDDS according to an embodiment of the present invention;

FIG. 8A shows the detailed structure of a TDFL according to an embodiment of the present invention;

FIG. 8B shows a data structure of a TDFL entry according to an embodiment of the present invention;

FIG. 9 is a flowchart illustrating a recording method according to an embodiment of the present invention; and

FIG. 10 is a flowchart illustrating a reproducing method according to an embodiment of the present invention.

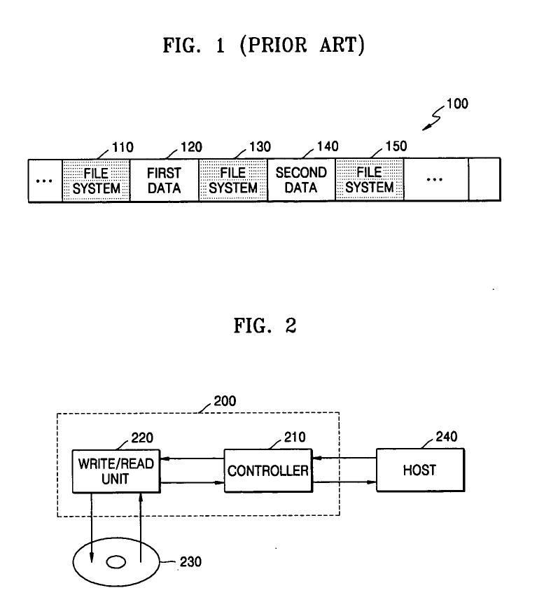

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Due to a logical overwrite on a write-once information storage medium, a temporary defect list (TDFL) increases in size and needs to be updated frequently. Therefore, a lifetime of a disk is decreased as a result of an exhausting of a temporary disk management area (TDMA) relatively fast. To resolve this problem, disk management information is compressed when the disk management information is written. By writing the compressed disk management information, the area required for writing may be reduced so as to increase a number of possible writes for the same area and increasing the disk lifetime. The compression of the disk management information includes compression of the TDMI, and particularly, compression of the TDFL.

FIG. 2 is a schematic block diagram of a recording/reproducing apparatus 200 according to an embodiment of the present invention.

Referring to FIG. 2, the recording/reproducing apparatus 200 includes a write/read unit 220 and a controller 210. Under the control of the controller 210, the write/read unit 220 writes data on a disk 230, which is an information storage medium according to the present embodiment, and reads data to reproduce the recorded data. The controller 210 controls the write/read unit 220 to write data in blocks of a recording unit according to the present embodiment, or obtains valid data by processing read data using the write/read unit 220.

In a recording operation, the controller 210 controls the write/read unit 220 to write data by performing logical overwrite according to the command of a host 240 or the control of the drive system itself. The logical overwrite means that an updating operation of the data written on the disk 230 is performed by a disk defect management method of managing defects generated on the disk 230.

The disk defect management method is a method of managing defects on a disk so as to increase the reliability of data written to the disk, including a slipping replacement method to process the defect detected in an initializing process for using the disk, and a linear replacement method to replace an ECC block unit including a defective sector with a defectless ECC block in a spare area with respect to the defect generated during use of the disk.

The slipping replacement method minimizes the decrease of recording or reproducing speed due to a defect by not assigning logical sector numbers to a defected sector detected in a verifying process to examine the defect of a disk when the disk is initialized, assigning the logical sector numbers of the defected sector to a subsequent sector of the defected sector by slipping the defected sector, and recording or reproducing data by neglecting and slipping the defected sector when a write or read operation is performed.

However, for a defect generated during use of a disk, the slipping replacement method cannot be used since a file system rule is violated due to discontinuity of logical sector numbers that is generated when a defected sector is neglected and slipped. When a defect is generated during use of a disk, the linear replacement method of replacing an ECC block including a defected sector by an ECC block in the spare area is used.

The controller 210 may use any one of the defect management methods to perform the logical overwrite. However, in an embodiment of the invention, the linear replacement method is used. A detailed description will be given later.

In a reproducing operation, the controller 210 controls the write/read unit 220 to read data according to the file system recording method used for the disk 230. That is, the controller 210 controls the write/read unit 220 to read defect list information stored on the disk 230, find the physical location at which the data is stored, and read the data at that location.

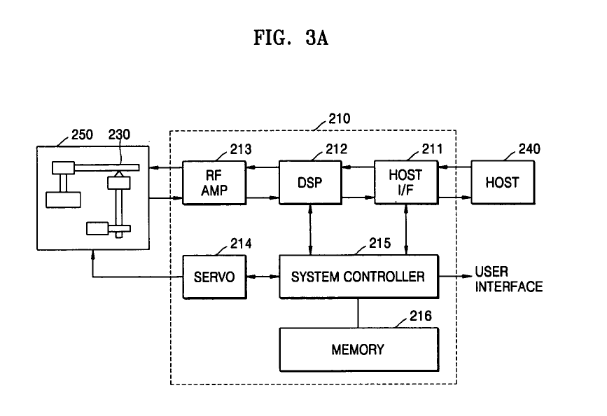

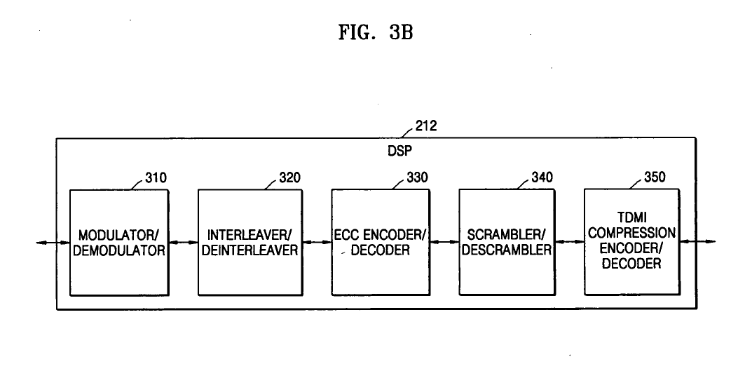

FIG. 3A is a detailed block diagram of the recording/reproducing apparatus 200 shown in FIG. 2.

Referring to FIG. 3A, a disk drive includes a pickup 250 as the write/read unit 220. The disk 230 is accessed by the pickup 250. The disk drive also includes a host interface (I/F) 211, a digital signal processor (DSP) 212, a radio frequency amplifier (RF AMP) 213, a servo 214, a system controller 215 and a memory 216 as the controller 210.

In a recording operation, the host I/F 211 receives data to be updated and a replacement enforcement write command according to an embodiment of the present invention, with logical address information of the data to be updated, together from the host 240, and transmits them to the system controller 215. According to an embodiment of the invention, the replacement enforcement write command may be issued by the system controller 215.

The system controller 215 receives the replacement enforcement write command from the host I/F 211 and performs initialization required to write data to the disk 230. In particular, according to the present embodiment, the system controller 215 analyzes the received replacement enforcement write command and controls other units to perform the writing based on the received command. That is, if the received command is the replacement enforcement write command, the system controller 215 controls the DSP 212 and the servo 214 to seek the address of an area in which the data to be updated is written, i.e. an unused area, and to write the received data to be updated at that address. After the data to be updated is written, the system controller 215 controls the DSP 212 and the servo 214 to generate a defect list and write the defect list to the disk 230. The defect list includes information on the physical address at which the data to be updated was first written (information on the physical address at which data was first written even if the data has been updated several times by the replacement enforcement write command) and information on the physical address at which the data to be updated is currently written.

According to the replacement enforcement write command, when data is updated, information on the data may be obtained at a fixed location, as in a rewritable information storage medium, by preparing a table to manage changed physical addresses without changing the logical addresses of the data.

The DSP 212 adds additional data, such as parity bits to correct errors to the data to be written, received from the host I/F 211, and generates an ECC block, which is an error correction block. The DSP 212 generates the ECC block by ECC encoding the data and by modulating the generated ECC block. The RF AMP 213 converts the data output from the DSP 212 to an RF signal. The pickup 250 writes the RF signal output from the RF AMP 213 on the disk 230. The servo 214 receives a command required for a servo control from the system controller 215 and servo-controls the pickup 250.

In particular, according to the present embodiment, the DSP 212 includes an encoder to compress temporary disk management information (TDMI), since a limited amount of TDMA space is quickly exhausted and the disk lifetime is reduced due to an increase of the size of the TDFL by performing the logical overwrite on the write-once information storage medium, and due to the frequent updating of the TDFL requested by a change of the defect list caused by the logical overwrite.

In a reproducing operation, the host I/F 211 receives a reproduction command from the host 240. The system controller 215 performs initialization required for the reproducing operation. In particular, according to the present embodiment, the system controller 215 controls the pickup 250 to read the area of the disk 230 in which the defect list is written, obtains information on the physical location at which data is written from the defect list, and reproduces the data from that physical location.

The pickup 250 radiates a laser beam on the disk 230 and receives the reflected laser beam to obtain an optical output signal. The RF AMP 213 converts the optical signal output from the pickup 250 to an RF signal, provides modulated data obtained from the RF signal to the DSP 212, and provides a servo signal for control obtained from the RF signal to the servo 214. The DSP 212 demodulates the modulated data and outputs data obtained through ECC error correction.

The servo 214 performs the servo control of the pickup 250 based on the servo signal that is received from the RF AMP 213 and the command required for the servo control received from the system controller 215. The host I/F 211 transmits the data received from the DSP 212 to the host 240.

FIG. 3B is a detailed block diagram of the DSP 212 shown in FIG. 3A. Referring to FIG. 3B, the DSP 212 includes a modulator/demodulator 310, an interleaver/deinterleaver 320, an ECC encoder/decoder 330, a scrambler/descrambler 340 and a TDMI compression encoder/decoder 350. When the TDMI is compressed and stored on the disk 230, the TDMI is compressed by the TDMI compression encoder/decoder 350, scrambled by the scrambler/descrambler 340, ECC-encoded by the ECC encoder/decoder 330, interleaved by the interleaver/deinterleaver 320, modulated by the modulator/demodulator 310, and stored on the disk 230. When the compressed TDMI is read from the disk 230, the compressed TDMI is demodulated by the modulator/demodulator 310, deinterleaved by the interleaver/deinterleaver 320, ECC-decoded by the ECC encoder/decoder 330, descrambled by the scrambler/descrambler 340, decompressed by TDMI compression encoder/decoder 350, and stored in an internal memory.

Compression methods used by the TDMI compression encoder/decoder 350 may include Run Length Encoding (RLE) and Huffman coding. Either a lossy or lossless compression scheme may be used, but in an embodiment of the invention, lossless compression is used for the TDMI since the TDMI is important for reproducing other data.

In general, in order to easily seek the final TDMI, the TDMA is continuously used due to the characteristics of the write-once information storage medium in which data cannot be overlapped.

When the TDMI is compressed, in an embodiment of the invention, data obtained by excluding the temporary disk definition structure (TDDS) from the TDMI is compressed.

In general, the size of the TDMI is variable, to cause an increase in the number of updating counts of the TDMI. If the entire TDMI is compressed, then, since the size of the TDMI cannot be known, reproduction of the final TDMI is difficult for the drive system. In addition, since the TDDS includes location pointers that direct the locations at which disk management information, including the TDMI is written, the drive system must first reproduce the TDDS to obtain the disk management information. In general, for the write-once information storage medium, due to a continuous use of the TDMA and a writing of the TDDS in a final recording block, the drive system may easily seek the TDDS later by accessing the final recording block in the TDMA. However, when the entire TDMI is compressed, if the compressed TDMI is comprised of a plurality of blocks, that the TDDS is written in the final block cannot be guaranteed. Thus, the drive system must first reproduce the entire TDMI so as to obtain the TDDS. A problem then occurs when reproducing the TDDS since the drive system cannot recognize the size of the TDMI.

In addition, according to an embodiment of the invention, each item of information of the TDMI is compressed separately. That is, according to the embodiment of the invention, the TDFL, a space bit map (SBM), and recording management information are compressed separately. In this case, if the size of each compressed item of information is not a multiple of a block or sector unit, the size of each compressed item of information is made to be a multiple of the block or sector unit by adding dummy data such as “00h”.

If the only information that requires an update so as to efficiently use the TDMA is actually updated, for example, if an update of the TDFL is required and the recording management information and the SBM do not have to be updated, the TDMA may be efficiently used by updating only the TDFL and the TDDS including location information of the TDFL. In addition, the TDDS includes information on each location pointer of the TDMI and the size of each compressed item of information. According to an embodiment of the invention, the information on the size of each compressed item of information is in block or sector units.

When each item of information included in the TDMI is compressed, in an embodiment of the invention, each item of information, from which header information of each of the items of information is excluded, is compressed. For example, when the TDFL is compressed, only TDFL entry information that is obtained by excluding header information from the TDFL is compressed.

An identifier may be stored at a specific location of a header of each item of information. The identifier determines which information a reproduced block is from the header information before each item of information is decompressed when each item of information is reproduced. For example, for the TDFL, a TDFL identifier is stored at a specific location of a TDFL header. When a compressed TDFL is reproduced from a TDFL location pointer which the TDDS directs, before the compressed TDFL is decompressed, the drive system may quickly recognize that the TDFL is reproduced from the TDFL identifier that is stored at the specific location of the TDFL header. This is due to the fact that header information is usually only a few bytes.

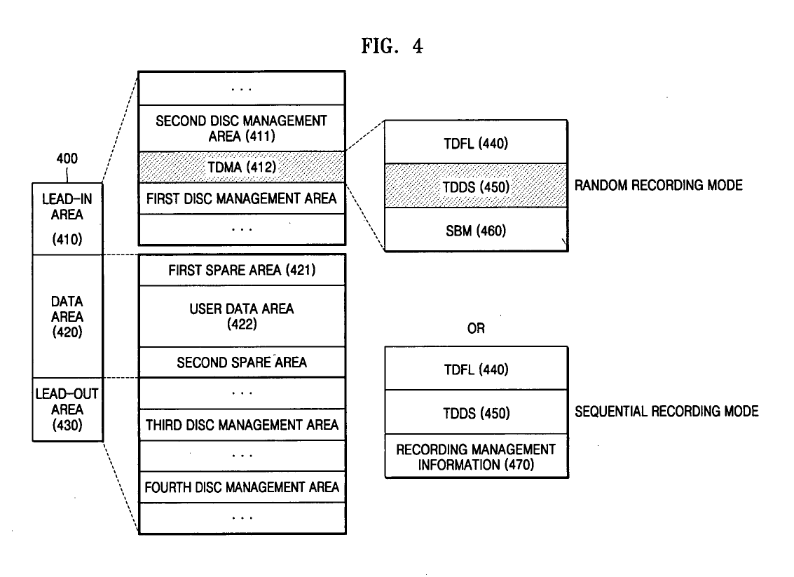

FIG. 4 shows the structure of a disk to which an embodiment of the present invention is applied. Referring to FIG. 4, the structure of data written on the write-once information storage medium 400 includes a lead-in area 410, a data area 420 and a lead-out area 430. The lead-in area 410 includes a disk management area 411 and a TDMA 412. The TDMA 412 is an area for recording information on temporary defect management and temporary disk management to manage the write-once information storage medium. The TDMA 412 includes a TDFL 440, a temporary disk definition structure (TDDS) 450 and an SBM 460 in the case where a recording mode is a random recording mode. The TDMA 412 includes the TDFL 440, the TDDS 450 and recording management information 470 in the case where the recording mode is a sequential recording mode.

The TDFL 440 includes a defect list comprised of defect state information, location information of a defect sector, and location information of a replacement sector. According to the present embodiment, the location information of a defect sector indicates the physical location at which pre-updated data is initially written. The location information of a replacement sector indicates the physical location at which updated data is written.

The TDDS 450 includes location pointers of the TDFL 440, the SBM 460 and a drive area, and further includes location and size information of spare areas that are assigned in an initializing operation, write protection information, location and size information of a temporary defect management area assigned in the data area 420, information on a user data area 422, information on a replaceable location in each spare area, and a last recording address in the user data area 422. The SBM 460 is a map indicating whether each cluster of the user data area 422 is recorded using a bit value.

The recording management information 470 represents a data recording state as entry information by dividing the user data area 422 into several areas, similar to that of the SBM 460. The entry information includes state information, start address information and last address information. Information on an area designated by the entry information is a recording state map of the user data area 422, represented as the state information of the area. The state information includes information on whether data is written in the area and whether the area is available.

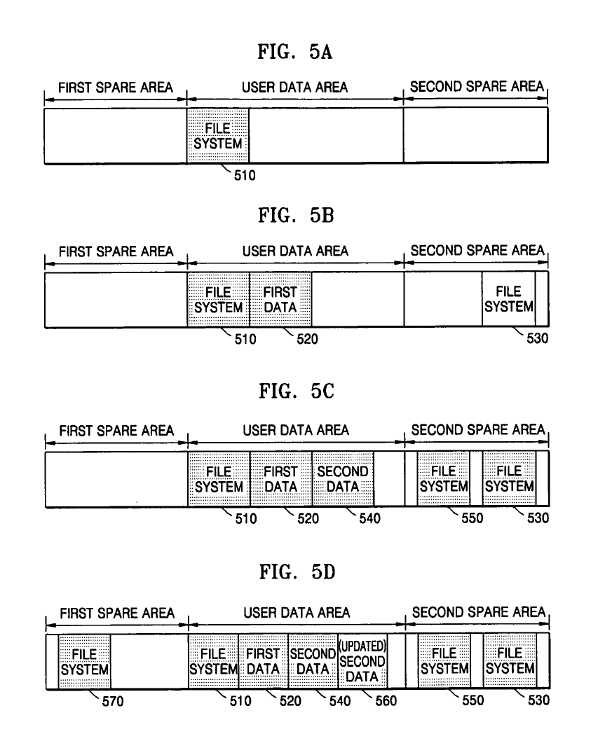

FIGS. 5A through 5D illustrate disk areas that are related to a recording operation using the logical overwrite according to an embodiment of the present invention. In these examples, file system data is logically overwritten. However, it is understood that the present invention is not limited to the embodiments illustrated in these FIGS., and may be equally applied to general user data.

FIG. 5A shows an initial file system written by assigning a file system 510 to manage user data to a fixed location, which is the beginning location of a user data area.

As shown in FIG. 5B, if first data 520 is recorded in the user data area, the file system 510 is modified. Thus, file system data is updated. In response to the command of a host or the control of the drive system itself, an updated file system 530 is recorded a second spare area by the linear replacement method, as in the method in which the file system 510 is replaced due to a defect. Here, in a defect list, location information of the file system 510 and location information of the file system 530 are recorded.

As shown in FIG. 5C, if second data 540 is recorded in the user data area, a file system 550 updated by the host or the drive system is recorded in the second spare area by the linear replacement method. Here, in the defect list, only the location information of the file system 510 and the location information of the file system 550 are recorded.

As shown in FIG. 5D, if updated second data 560 is recorded in the user data area, an updated file system 570 is recorded in a first spare area by the linear replacement method. Here, in the defect list, only the location information of the file system 510 and the location information of the file system 570 are recorded. The defect list will be described in more detail.

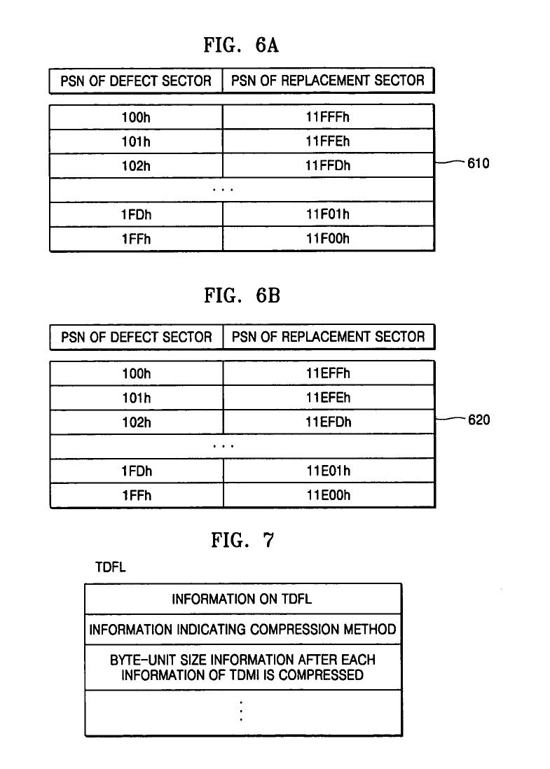

FIGS. 6A and 6B illustrate the defect list according to an embodiment of the present invention. Examples of the defect list recorded by a control of the controller 210 will be described with reference to FIGS. 6A and 6B. For example, assuming that physical sector numbers of the user data area corresponding to logical sector numbers 00h to FFh are 100h to 1FFh (a recording area of the file system 530 of FIG. 5A), and data corresponding to the logical sector numbers 00h to FFh is updated in physical sector numbers 11FFFh to 11F00h of the spare area (a recording area of the file system 530 of FIG. 5B) by the host or the drive system, a defect list 610 including defect sector information and replacement sector information is shown in FIG. 6A.

After the defect list 610 is made, if data corresponding to the logical sector numbers 00h to FFh is updated in physical sector numbers 11EFFh to 11E00h of the spare area, defect sector information and replacement sector information of a defect list 620 is shown in FIG. 6B. Therefore, the last file system may be found using the fixed logical sector numbers by seeking the last defect list 620 including last physical sector numbers corresponding to the logical sector numbers. Likewise, by updating a file system using the disk defect management method when data is updated, the address of the file system may be obtained at a fixed location by fixing logical sector numbers of file system data.

FIG. 7 shows the detailed structure of a TDDS according to an embodiment of the present invention. Referring to FIG. 7, the TDDS includes information on a TDFL, information indicating the compression method, and byte-unit size information after each TDMI is compressed.

In an embodiment of the invention, the byte-unit size information after each TDMI is compressed is either: 1) information obtained by adding the byte size of the TDFL and the byte size of the compressed TDFL entries, or 2) the byte size of the compressed TDFL entries. In other words, the byte-unit size information after each TDMI is compressed does not include dummy data such as 00h to make the size of the TDFL a multiple of the size of a sector, since decompression cannot be performed without the actual size of the compressed data.

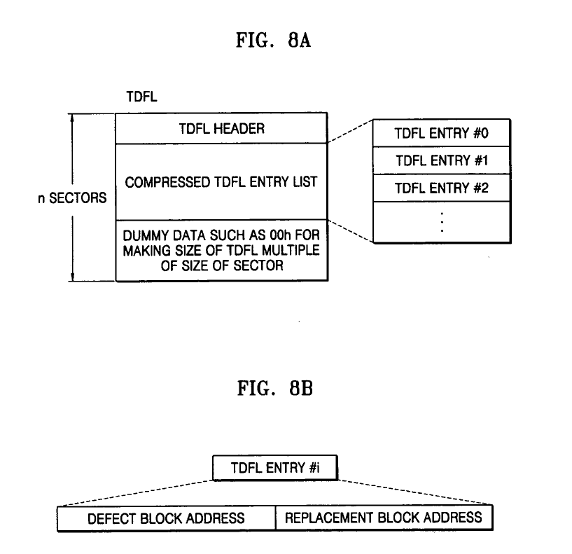

FIG. 8A shows the detailed structure of the TDFL according to an embodiment of the present invention. Referring to FIG. 8A, the TDFL includes a TDFL header to identify the TDFL, a compressed TDFL entry list, and dummy data such as 00h to make the size of the TDFL a multiple of the size of a sector. The compressed TDFL entry list is a list of TDFL entries. The TDFL is constituted of n sectors, wherein n is an integer.

FIG. 8B shows a data structure of a TDFL entry according to an embodiment of the present invention. Referring to FIG. 8B, each TDFL entry #i includes a defect block address and a replacement block address. For example, the defect block address indicates the physical sector number of a defect block, and the replacement block address indicates the physical sector number of a replacement block.

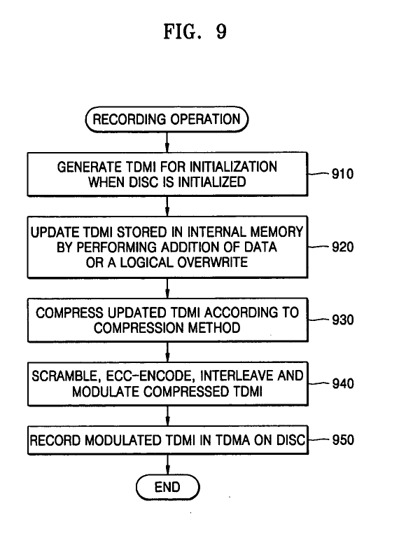

FIG. 9 is a flowchart illustrating a recording method according to an embodiment of the present invention. Referring to FIG. 9, when initialization is performed, a system controller generates a TDMI for initialization according to an initialization command of a host or the drive system, in operation 910, and if an update of the TDMI is requested by performing addition of data or a logical overwrite, the system controller updates the TDMI stored in an internal memory of the drive system in operation 920. The updated TDMI is compressed in operation 930. The compressed TDMI is scrambled, ECC-encoded, interleaved, and modulated, in operation 940. The modulated TDMI is recorded in a TDMA on a disk in operation 950.

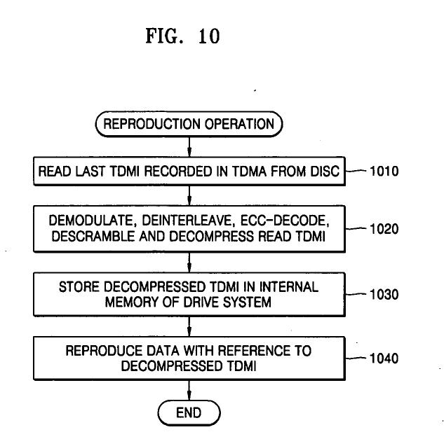

FIG. 10 is a flowchart illustrating a reproducing method according to an embodiment of the present invention. Referring to FIG. 10, a last (compressed) TDMI recorded in a TDMA is read from the disk in operation 1010. The read (compressed) TDMI is demodulated, deinterleaved, ECC-decoded, descrambled, and decompressed, in operation 1020. The decompressed TDMI is stored in an internal memory of the drive system in operation 1030. Data is reproduced with reference to the decompressed TDMI stored in the internal memory, in operation 1040.

The above embodiments have been described with reference to a write-once information storage medium, but the present invention is not limited to this type of information storage medium. Even for rewritable information storage media, the rewriting count is limited to a certain degree since repeated rewriting degrades data reliability. In this case, after many rewrites, data may be recorded using a replacement request write command according to an embodiment of the present invention, though a component such as a rewriting counter is required. Though file system data is described as updated data in embodiments of the present invention, it will be understood by those of ordinary skill in the art that a recording method according to an embodiment of the present invention can also be applied to user data without being limited to the file system data.

The embodiments of the present invention may be written as computer programs and may be implemented in general-use digital computers that execute the programs using a computer readable recording medium. Examples of the computer readable recording medium include magnetic storage media (e.g. ROM, floppy disks, hard disks, etc.), optical recording media (e.g. CD-ROMs, DVDs, etc.), and storage media such as carrier waves (e.g. transmission through the internet). The computer readable recording medium can also be distributed over network coupled computer systems so that the computer readable code is stored and executed in a distributed fashion.

As is described above, according to embodiments of the present invention, all or part of a write-once information storage medium may be used as a rewritable information storage medium by updating data according to a defect management method, and in particular, the lifetime of the disk may be extended.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A recording apparatus to record data on an information storage medium, the apparatus comprising:
a write unit which writes the data on the medium; and
a controller which compresses temporary disk management information (TDMI), which is information to manage the medium, and controls the write unit to write the compressed TDMI in a disk management area of the information storage medium.

2. The apparatus of claim 1, wherein the compressed TDMI excludes a temporary disk definition structure (TDDS).

3. The apparatus of claim 2, wherein the controller separately compresses each item of information included in the TDMI.

4. The apparatus of claim 3, wherein the controller excludes header information when the TDMI is compressed.

5. A reproducing apparatus to reproduce data from an information storage medium, the apparatus comprising:
a read unit which reads the data from the medium; and
a controller which decompresses temporary disk management information (TDMI) written on the medium when the data written on the medium is reproduced, and uses the decompressed TDMI for data reproduction.

6. The apparatus of claim 5, wherein the compressed TDMI excludes a temporary disk definition structure (TDDS).

7. The apparatus of claim 6, wherein the controller separately decompress each item of information included in the TDMI.

8. The apparatus of claim 7, wherein the controller excludes header information when the TDMI is decompressed.

9. An information storage medium in which temporary disk management information (TDMI) is compressed and recorded in a disk management area.

10. The medium of claim 9, wherein the compressed TDMI excludes a temporary disk definition structure (TDDS).

11. The medium of claim 10, wherein each item of information included in the TDMI is separately compressed and written.

12. The medium of claim 11, wherein header information is excluded when the TDMI is compressed.

13. A disk drive to record and reproduce information to and from a disk, comprising:
a servo controlled pickup to read/write information from/to the disk;
an interface (I/F) to receive a write command or a read command from a host;
a digital signal processor (DSP) to add additional data to correct errors to data to be updated, to generate a data output including an error correction (ECC) block, and to compress or decompress temporary disk management information;
a radio frequency amplifier (RF AMP) to convert the data output from the DSP to an RF signal which is written onto the disk by the pickup; and
a controller to control the pickup, the interface, the DSP and the RF AMP to record and reproduce information to and from the disk.

14. A digital signal processor (DSP) of a recording/reproducing apparatus to record/reproduce information to/from a disk including a temporary disk management area (TDMA), comprising:
a modulator/demodulator to demodulate compressed temporary disk management information (TDMI);
an interleaver/deinterleaver to deinterleave the demodulated TDMI;
an error correction (ECC) encoder/decoder to ECC decode the deinterleaved TDMI;
a scrambler/descrambler to descramble the ECC decoded TDMI; and
a TDMI compression encoder/decoder to decompress the descrambled TDMI, wherein the DSP also operates in a reverse direction to compress and store the TDMI.

15. The DSP according to claim 14, wherein the TDMI compression encoder/decoder employs one of Run Length Encoding (RLE) and Huffman coding.

16. The DSP according to claim 14, wherein one of a lossy and a lossless compression scheme is used.

17. The DSP according to claim 14, wherein, when the TDMI is compressed, data that is obtained by excluding the temporary disk definition structure (TDDS) from the TDMI is compressed.

18. The DSP according to claim 14, wherein a size of the TDMI is variable, to cause an increase in the number of updating counts of the TDMI.

19. The DSP according to claim 14, wherein each item of information of the TDMI is compressed separately.

20. The DSP according to claim 19, wherein a space bit map (SBM) and recording management information of the TDMI are compressed separately.

21. The DSP according to claim 20, wherein, if the size of each compressed item of information is not a multiple of a block or sector unit, the size of each compressed item of information is made to be a multiple of the block or sector unit by adding dummy data.

22. The DSP according to claim 21, wherein, when each item of information included in the TDMI is compressed, each item of information, from which header information of each of the items of information is excluded, is compressed.

23. The DSP according to claim 22, wherein an identifier is stored at a specific location of a header of each item of information.

24. The DSP according to claim 23, wherein the identifier determines which information a reproduced block is from the header information before each item of information is decompressed when each item of information is reproduced.

25. A lead-in area of a disk structure, including a disk management area and a temporary disk management area (TDMA) to record information on temporary defect management and temporary disk management, the information comprising:
a temporary defect list (TDFL) including a defect list of defect state information, location information of a defect sector of the disk, and location information of a replacement sector of the disk;
a space bit map (SBM) in a random recording mode to indicate whether clusters of a user data area are recorded using a bit value or recording management information in a sequential recording mode; and
a temporary disk definition structure (TDDS) including location pointers of the TDFL, the SBM, and a drive area, location and size information of spare areas that are assigned in an initializing operation, write protection information, location and size information of the TDMA assigned in a data area, information on the user data area, information on a replaceable location in each spare area, and a last recording address in the user data area, wherein the TDFL and the SBM are separately compressed and the TDSS is not compressed.

26. A data recording method to be used with a storage medium of a recording/reproducing apparatus, the method comprising:
generating temporary disk management information (TDMI) of the storage medium;
if an update of the TDMI is requested, performing an addition of data or a logical overwrite of the TDMI; and
compressing, scrambling, error correction (ECC) encoding, interleaving, and modulating the updated TDMI, wherein the method is operable in reverse so as to reproduce the data.

27. The apparatus of claim 1, wherein the information storage medium is a write once disk.
